(19) United States
(12) Patent Application Publication
(10) Pub. No.: US 2026/0357738 A1
(43) Pub. Date: Nov. 12, 2026

(54) PUMP WITH PRINTED CIRCUIT BOARD

(71) Applicant: Stant USA Corp., Connersville, IN (US)

(72) Inventors: Lukas Dzurec, Ostrava (CZ); Jan Nimrichter, Ostrava (CZ)

(21) Appl. No.: 19/672,222

(22) Filed: May 8, 2026

Related U.S. Application Data
(60) Provisional application No. 63/802,297, filed on May 8, 2025.

(51) Int. Cl. F01P 5/12; F04D 25/06; F04D 29/08; H02K 3/26; H02K 7/14

(52) U.S. Cl. CPC F01P 5/12; F04D 25/0606; F04D 29/086; H02K 3/26; H02K 7/14; F01P 2005/125; H02K 2211/03

(57) ABSTRACT

A fluid pump adapted for use in different systems of a vehicle, such as a vapor recovery or fuel system, a thermal management system, and/or a window and/or sensor washing system. The fluid pump includes a pump housing, an impeller assembly arranged in a fluid section of the pump housing, and a printed circuit board stator arranged in a sealed section of the pump housing.

### PRIORITY CLAIMS

This application claims priority to and the benefit of U.S. Provisional Patent Application Number 63/802,297, filed 08 May 2025, the disclosure of which is now expressly incorporated herein by reference.

### TECHNICAL FIELD

The present disclosure relates generally to fluid pumps, and more specifically to fluid pumps adapted for use in systems on a vehicle.

### Background

Vehicle systems, i.e., fuel systems, vapor recovery systems, thermal management systems, window and/or sensor washing systems, etc., may use fluid pumps to conduct fluid to the different components. Conventional pumps may use a radial flux motor to drive rotation of an external impeller, which can expose electrical components to harsh conditions.

### SUMMARY

The present disclosure may comprise one or more of the following features and combinations thereof.

A fluid pump adapted for use on a vehicle may include a pump housing, an impeller assembly, and a printed circuit board stator. The pump housing may have a cavity divided into a fluid section and a sealed section. The impeller assembly may be arranged in the fluid section of the pump housing and configured to rotate about an axis to generate a flow of the fluid through the pump housing. The printed circuit board stator is arranged in the sealed section of the pump housing adjacent to a plurality of magnets on an impeller of the impeller assembly. The printed circuit board stator has copper traces configured to generate a magnetic field when an electrical current is introduced that interacts with the plurality of magnets on the impeller body to cause the impeller assembly to rotate about the axis.

In some embodiments, the printed circuit board stator may be arranged in the sealed section of the pump housing so that electronics of the printed circuit board stator are sealed off from the fluid. The printed circuit board stator is sealed in the sealed section to protect the electronics of the printed circuit board stator from being exposed to the fluid flowing through the pump housing.

In some embodiments, the pump housing includes a top or first housing body, a bottom or second housing body, and a partition. The bottom housing body and the top housing body may be coupled together to define the cavity therebetween. The partition may be arranged in the cavity axially between the bottom housing body and the top housing body relative to an axis to divide the cavity into the fluid section and the sealed section.

In some embodiments, the impeller assembly may include an impeller and a plurality of magnets. The impeller may be configured to rotate about the axis to generate a flow of the fluid through the pump housing. The plurality of magnets coupled to the impeller for rotation therewith and spaced apart circumferentially about the axis.

In some embodiments, the fluid pump may further include a seal member. The seal member may be arranged between the partition and at least one of the bottom housing body and the top housing body of the pump housing to seal the sealed section of the cavity from the fluid section.. In some embodiments, the seal member may be arranged between the bottom housing body, the top housing body, and the partition of the pump housing to seal the sealed section of the cavity from the fluid section. In some embodiments, the seal member may be arranged axially between the bottom housing body and the partition of the pump housing. In some embodiments, the seal member may be arranged axially between the top housing body and the partition of the pump housing.

In some embodiments, the impeller may include an impeller disk, a plurality of impeller blades, and an impeller shroud. The impeller disk may extend circumferentially about the axis. The plurality of impeller blades may extend axially away from a first side of the impeller disk. The impeller shroud may be arranged over the plurality of impeller blades to direct the fluid through the impeller in between the plurality of impeller blades and impede the fluid from passing over tips of the plurality of impeller blades. The plurality of magnets may be coupled to a second side of the impeller disk opposite the first side.

In some embodiments, the printed circuit board stator may have a center aperture. The center aperture may extend axially therethrough and a portion of the partition may be arranged in the center aperture. The portion of the partition may be arranged in the center aperture so that the printed circuit board stator sits flush on a circumferential wall of the partition.

In some embodiments, the circumferential wall may have a minimum axial thickness at a location arranged between the plurality of magnets of the impeller assembly and the copper traces of the printed circuit board stator. The circumferential wall may have a minimum axial thickness at this location so that the axial thickness of the partition is the smallest between the magnets of the impeller assembly and the copper traces of the printed circuit board stator.

In some embodiments, the top housing body may include a top wall, an annular outer wall, an inlet pipe, and an outlet pipe. The top wall may extend circumferentially about the axis. The annular outer wall may extend axially from an outer rim of the top wall toward the bottom housing body. The inlet pipe may extend axially from the top wall at a center of the top wall away from the bottom housing body. The outlet pipe may extend radially away from the annular outer wall.

In some embodiments, the bottom housing body may include a bottom wall and at least one annular lip. The bottom wall may extend circumferentially about the axis. The annular lip may extend axially from the bottom wall toward the top housing body radially inward of an outer edge of the bottom wall. In some embodiments, the bottom wall of the bottom housing body may be formed to include a plurality of openings spaced apart circumferentially about the axis that open to a portion of the printed circuit board stator.

In some embodiments, the impeller assembly may further include an impeller axle assembly that extends along the axis. In some embodiments, the impeller axle assembly may rotate about the axis. The impeller axle assembly may support the impeller body for rotation about the axis.

In some embodiments, the impeller axle assembly may include an impeller axle, an impeller bushing, and a ball bearing assembly. The impeller axle may extend axially along the axis between a first end and a second end spaced apart axially from the first end. The impeller bushing may be arranged at the first end of the impeller axle between the impeller axle and the impeller. The ball bearing assembly may be arranged at the second end of the impeller axle between the impeller axle and the partition.

In some embodiments, the impeller axle assembly may include an impeller axle and impeller bushings. The impeller axle may extend axially along the axis between a first end and a second end spaced apart axially from the first end. The impeller bushings may be arranged around the impeller axle between the impeller axle and the impeller.

According to another aspect of the present disclosure, a fluid pump may comprise a pump housing, an impeller assembly, and a printed circuit board stator. The pump housing may be formed to define a cavity. The pump housing may include a partition arranged in the cavity to divide the cavity into a fluid section and a sealed section that is separate from the fluid section. The impeller assembly may be arranged in the fluid section of the pump housing. The printed circuit board stator may be arranged in the sealed section of the pump housing adjacent to the plurality of magnets of the impeller assembly.

In some embodiments, the impeller assembly may include an impeller and a plurality of magnets. The impeller may be configured to rotate about an axis to generate a flow of the fluid through the pump housing. The plurality of magnets may be coupled to the impeller for rotation therewith and spaced apart circumferentially about the axis.

In some embodiments, the printed circuit board stator may have copper traces configured to generate a magnetic field that interacts with the plurality of magnets on the impeller. The interaction of the magnetic field generated by the copper traces with the magnets may cause the impeller assembly to rotate about the axis. The printed circuit board stator may be arranged in the sealed section of the pump housing so that electronics of the printed circuit board stator are sealed off from the fluid in the fluid section to protect the electronics of the printed circuit board stator from being exposed to the fluid flowing through the pump housing.

In some embodiments, the fluid pump may further comprise a seal member. The seal member may be arranged between a portion of the pump housing and the partition to seal the sealed section of the cavity from the fluid section.

In some embodiments, the impeller may include an impeller disk, a plurality of impeller blades, and a impeller shroud. The impeller disk may extend circumferentially about the axis. The plurality of impeller blades may extend axially away from a first side of the impeller disk. The impeller shroud may be arranged over the plurality of impeller blades to direct the fluid through the impeller in between the plurality of impeller blades and impede the fluid from passing over tips of the plurality of impeller blades. In some embodiments, the plurality of magnets may be coupled to a second side of the impeller disk opposite the first side.

In some embodiments, the printed circuit board stator may have a center aperture that extends axially therethrough. A portion of the partition may be arranged in the center aperture. The portion of the partition may be arranged in the center aperture so that the printed circuit board stator sits flush on a circumferential wall of the partition. In some embodiments, the circumferential wall of the partition may have a minimum axial thickness at a location arranged between the plurality of magnets of the impeller assembly and the copper traces of the printed circuit board stator.

In some embodiments, the pump housing may further include a first housing body and a second housing body. The second housing body may be coupled to the top housing body to define the cavity therebetween. The impeller assembly may be arranged axially between the first housing body and the partition in the fluid section of the cavity. The printed circuit board stator may be arranged axially between the partition and the second housing body in the sealed section of the cavity.

In some embodiments, the second housing body may be formed to include a plurality of openings. The plurality of openings may be spaced apart circumferentially about the axis. The plurality of openings may open to a portion of the printed circuit board stator.

According to another aspect of the present disclosure, a fuel system adapted for use on a vehicle may include the fluid pump. The fuel system may include a fuel tank, a canister housing formed to define a storage cavity containing a carbon bed configured to absorb hydrocarbons in flue vapor from the fuel tank that flows into and out of the storage cavity, a fuel tank isolation valve coupled between the fuel tank and the canister housing and configured to regulate a flow of fuel vapor between the fuel tank and the storage cavity of the canister housing, and a purge pump in fluid communication with the storage cavity of the canister housing and configured to draw fuel vapor from the storage cavity to the fuel tank during unwanted vacuum conditions in the fuel tank.

In some embodiments, the purge pump may comprise a pump housing, an impeller assembly, and a printed circuit board stator. The pump housing may include a bottom housing body, a top housing body coupled to the bottom housing body to define a cavity therebetween, and a partition arranged in the cavity axially between the bottom housing body and the top housing body relative to an axis to divide the cavity into a fuel vapor section and a sealed section. The impeller assembly may be arranged in the in the fuel vapor section of the pump housing and the printed circuit board stator may be arranged in the sealed section of the pump housing adjacent to a plurality of magnets of the impeller assembly.

In some embodiments, the impeller assembly may include an impeller and a plurality of magnets. The impeller may be configured to rotate about the axis to generate a flow of the fuel vapor through the pump housing. The plurality of magnets may be coupled to the impeller for rotation therewith and spaced apart circumferentially about the axis.

In some embodiments, the printed circuit board stator may have copper traces configured to generate a magnetic field that interacts with the plurality of magnets on the impeller to cause the impeller assembly to rotate about the axis. The printed circuit board stator may be arranged in the sealed section of the pump housing so that electronics of the printed circuit board stator are sealed off from the fuel vapor to protect the electronics of the printed circuit board stator from being exposed to the fuel vapor flowing through the pump housing.

According to another aspect of the present disclosure, a thermal management system adapted for use on a vehicle may include the fluid pump. The thermal management system may include a plurality of fluid circuits that each includes a conduit configured to conduct coolant fluid therethrough and adapted to be in thermal communication with at least one of (i) front and rear drives included in the vehicle to transfer heat between the front and rear drives and the coolant fluid, (ii) a radiator included in the vehicle to transfer heat between the radiator and the coolant fluid, (iii) batteries included in the vehicle to transfer heat between the batteries and the coolant fluid, and (iv) a heat exchanger to transfer heat between the coolant fluid and a fluid in the heat exchanger, a coolant tank formed to define a coolant reservoir configured to store the coolant fluid, and at least one pump configured to pump a flow of the coolant fluid from the coolant tank through the plurality of fluid circuits.

In some embodiments, the pump may comprise a pump housing, an impeller assembly, and a printed circuit board stator. The pump housing may include a bottom housing body, a top housing body coupled to the bottom housing body to define a cavity therebetween, and a partition arranged in the cavity axially between the bottom housing body and the top housing body relative to an axis to divide the cavity into a cooling fluid section and a sealed section. The impeller assembly may be arranged in the in the cooling fluid section of the pump housing and the printed circuit board stator may be arranged in the sealed section of the pump housing adjacent to a plurality of magnets of the impeller assembly.

In some embodiments, the impeller assembly may include an impeller and a plurality of magnets. The impeller may be configured to rotate about an axis to generate a flow of the fuel vapor through the pump housing. The plurality of magnets may be coupled to the impeller for rotation therewith and spaced apart circumferentially about the axis.

In some embodiments, the printed circuit board stator may have copper traces configured to generate a magnetic field that interacts with the plurality of magnets on the impeller to cause the impeller assembly to rotate about the axis. The printed circuit board stator may be arranged in the sealed section of the pump housing so that electronics of the printed circuit board stator are sealed off from the fuel vapor to protect the electronics of the printed circuit board stator from being exposed to the fuel vapor flowing through the pump housing.

According to another aspect of the present disclosure, a high-pressure washing system adapted for use on a vehicle may include the fluid pump. The washing system may include a washer fluid tank configured to store a washer fluid, at least one washer fluid nozzle in fluid communication with the washer fluid tank, and a fluid pump coupled in fluid communication with the washer fluid tank and the at least one washer fluid nozzle to provide a flow of washer fluid to the at least one washer fluid nozzle.

In some embodiments, the pump may comprise a pump housing, an impeller assembly, and a printed circuit board stator. The pump housing may include a bottom housing body, a top housing body coupled to the bottom housing body to define a cavity therebetween, and a partition arranged in the cavity axially between the bottom housing body and the top housing body relative to an axis to divide the cavity into a washer fluid section and a sealed section. The impeller assembly may be arranged in the in the washer fluid section of the pump housing and the printed circuit board stator may be arranged in the sealed section of the pump housing adjacent to a plurality of magnets of the impeller assembly.

In some embodiments, the impeller assembly may include an impeller and a plurality of magnets. The impeller may be configured to rotate about an axis to generate a flow of the fuel vapor through the pump housing. The plurality of magnets may be coupled to the impeller for rotation therewith and spaced apart circumferentially about the axis.

In some embodiments, the printed circuit board stator may have copper traces configured to generate a magnetic field that interacts with the plurality of magnets on the impeller to cause the impeller assembly to rotate about the axis. The printed circuit board stator may be arranged in the sealed section of the pump housing so that electronics of the printed circuit board stator are sealed off from the fuel vapor to protect the electronics of the printed circuit board stator from being exposed to the fuel vapor flowing through the pump housing.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a fluid pump in accordance with the present disclosure adapted for use in different systems shown in FIGS. 11-13;

FIG. 2 is a cross-sectional view of the fluid pump of FIG. 1 taken along line 2-2 showing the fluid pump includes (i) a pump housing that defines a cavity with a fluid section and a sealed section, an inlet in fluid communication with the fluid section of the cavity, and an outlet in fluid communication with the fluid section of the cavity, (ii) an impeller assembly arranged in the fluid section configured to rotate about the axis to generate a flow of the fluid through the pump housing, and (iii) a printed circuit board stator arranged in the sealed section of the pump housing adjacent to a plurality of magnets included in the impeller assembly so that electronics of the printed circuit board stator are sealed off from the fluid to protect the electronics of the printed circuit board stator from being exposed to the fluid;

FIG. 3 is an exploded view of the fluid pump of FIG. 1 showing the fluid pump includes (i) the pump housing including a bottom housing body, a top housing body to be coupled to the bottom housing to define the cavity therebetween, and a partition to be arranged in the cavity axially between the bottom housing body and the top housing body to divide the cavity into the fluid section and the sealed section, (ii) the impeller assembly including an impeller body configured to rotate about the axis to generate a flow of the fluid through the pump housing and a plurality of magnets to be coupled to the impeller body for rotation therewith, (iii) the printed circuit board stator having copper traces configured to generate a magnetic field that interacts with the plurality of magnets on the impeller body to cause the impeller assembly to rotate about the axis, and (iv) a seal member to be arranged between the bottom housing body, the top housing body, and the partition of the pump housing to help seal the sealed section of the cavity from the fluid section;

FIG. 4 is a cross-section view of the fluid pump of FIG. 1 showing the impeller assembly is arranged in the fluid section of the pump housing and the printed circuit board stator is arranged in the seal section of the pump housing,

FIG. 5 is a detail view of the fluid pump of FIG. 4 showing the partition has a relatively small thickness at a location between the magnets of the impeller assembly and the copper traces of the printed circuit board stator;

FIG. 6 is a perspective view of another embodiment of a fluid pump adapted for use in different systems shown in FIGS. 11-13;

FIG. 7 is a cross-sectional view of the fluid pump of FIG. 6 taken along line 7-7 showing the fluid pump includes (i) a pump housing that defines a cavity with a fluid section and a sealed section, (ii) an impeller assembly arranged in the fluid section configured to rotate about the axis to generate a flow of the fluid through the pump housing, and (iii) a printed circuit board stator arranged in the sealed section of the pump housing adjacent to a plurality of magnets included in the impeller assembly so that electronics of the printed circuit board stator are sealed off from the fluid to protect the electronics of the printed circuit board stator from being exposed to the fluid;

FIG. 8 is an exploded view of the fluid pump of FIG. 6 showing the fluid pump includes (i) the pump housing including a bottom housing body, a top housing body to be coupled to the bottom housing to define the cavity therebetween, and a partition to be arranged in the cavity axially between the bottom housing body and the top housing body to divide the cavity into the fluid section and the sealed section, (ii) the impeller assembly including an impeller body configured to rotate about the axis to generate a flow of the fluid through the pump housing and a plurality of magnets to be coupled to the impeller body for rotation therewith, (iii) the printed circuit board stator having copper traces configured to generate a magnetic field that interacts with the plurality of magnets on the impeller body to cause the impeller assembly to rotate about the axis, and (iv) a seal member to be arranged between the bottom housing body, the top housing body, and the partition of the pump housing to help seal the sealed section of the cavity from the fluid section;

FIG. 9 is a cross-section view of the fluid pump of FIG. 6 showing the impeller assembly is arranged in the fluid section of the pump housing and the printed circuit board stator is arranged in the seal section of the pump housing;

FIG. 10 is a detail view of the fluid pump of FIG. 9 showing the partition has a relatively small thickness at a location between the magnets of the impeller assembly and the copper traces of the printed circuit board stator;

FIG. 11 is diagrammatic view of a fuel system adapted for use on a vehicle showing the fuel system includes a fuel tank, a canister housing formed to define a storage cavity containing a carbon bed configured to absorb hydrocarbons in flue vapor from the fuel tank that flows into and out of the storage cavity, a fuel tank isolation valve coupled between the fuel tank and the canister housing and configured to regulate the flow of fuel vapor between the fuel tank and the storage cavity of the canister housing, and a purge pump like the fluid pumps of FIGS. 1 or 6 configured to draw fuel vapor from the storage cavity to the fuel tank during unwanted vacuum conditions in the fuel tank;

FIG. 12 is a diagrammatic view of a thermal management system adapted for use on a vehicle showing the thermal management system includes a plurality of fluid circuits that each includes a conduit configured to conduct coolant fluid therethrough and adapted to be in thermal communication with at least one component of the vehicle (e.g., front and rear drives, a radiator, batteries, a heat exchanger, etc.), and at least one pump like the fluid pumps of FIGS. 1 or 6 configured to pump a flow of the coolant fluid from the coolant tank through the plurality of fluid circuits, the at least one pump comprising; and

FIG. 13 is a diagrammatic view of a high-pressure washing system adapted for use on a vehicle showing the high-pressure washing system includes a washer fluid tank configured to store a washer fluid and a fluid pump like the fluid pumps of FIGS. 1 or 6 coupled in fluid communication with the washer fluid tank to provide a flow of washer fluid.

### DETAILED DESCRIPTION

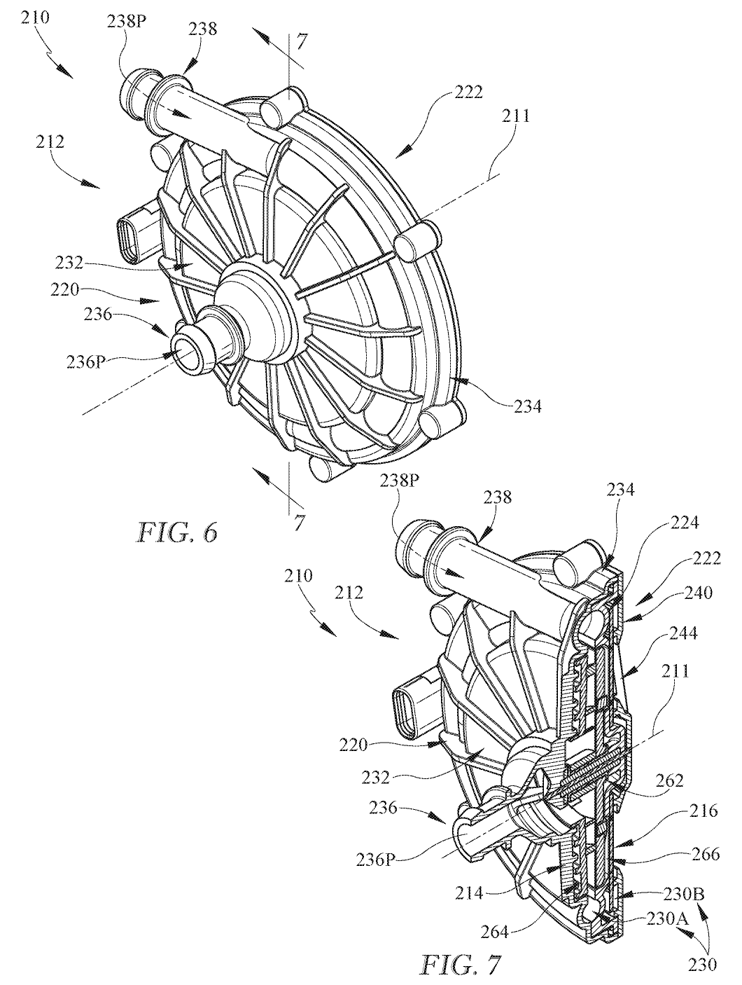

FIGS. 1-10 show embodiments of an illustrative fluid pump 10, 210 in accordance with the present disclosure. A first embodiment of a fluid pump 10 is shown in FIGS. 1-5. A second embodiment of a fluid pump 210 is shown in FIGS. 6-10. The fluid pumps 10, 210 include an integrated impeller-rotor assembly 14, 214 arranged in a fluid section of a pump housing 12, 212 and a printed circuit board (PCB) stator 16, 216 arranged in a sealed section 30B, 234 of the pump housing 12, 212. The hermetically sealed PCB stator 16, 216 protects the electronics from exposure to the fluid flowing through the pump 10, 210.

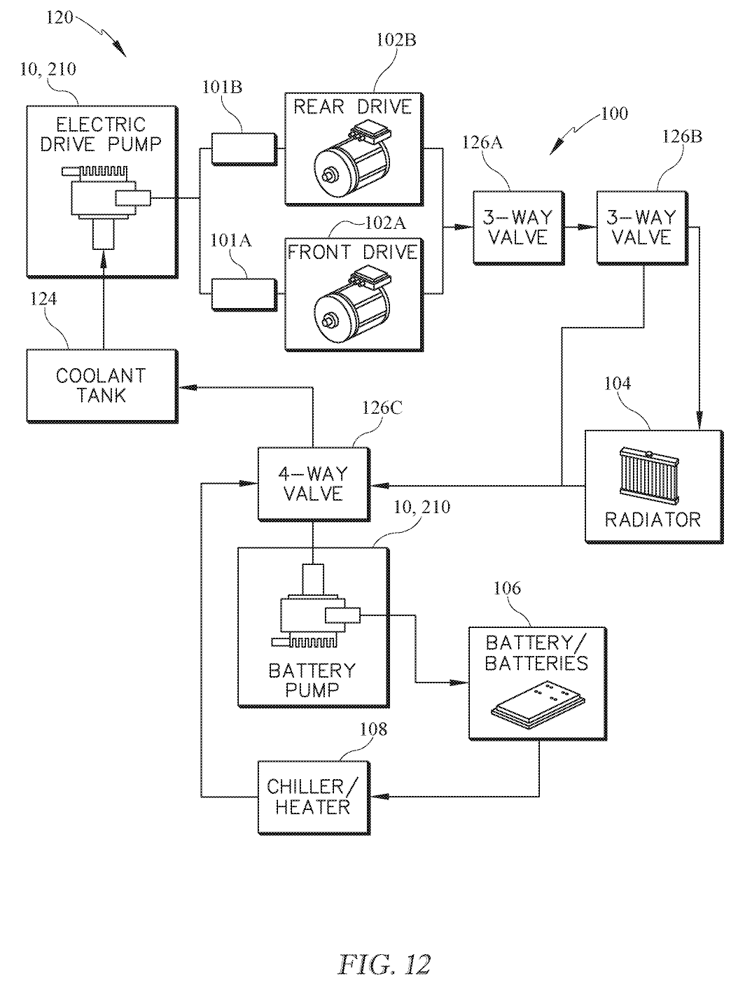

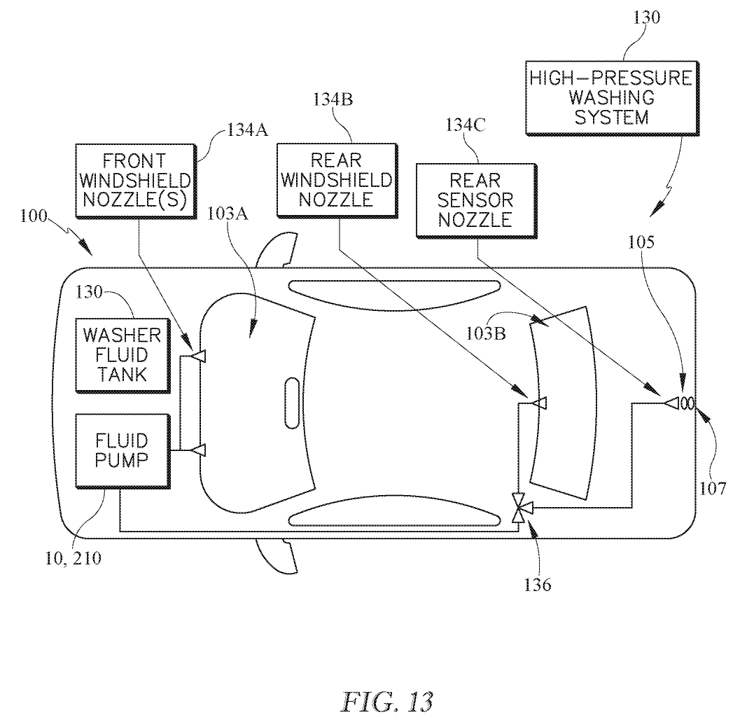

The fluid pumps 10, 210 may be adapted for use in various different systems for a vehicle 100 as suggested in FIGS. 11-13. For example, the fluid pump 10, 210 may be included in a vapor recovery or fuel system 110 like as shown in FIG. 11. In some embodiments, the fluid pump 10, 210 may be included in a thermal management system 120 like as shown in FIG. 12. In other embodiments, the fluid pump 10, 210 may be included in a window and/or sensor washing system 130 like as shown in FIG. 13.

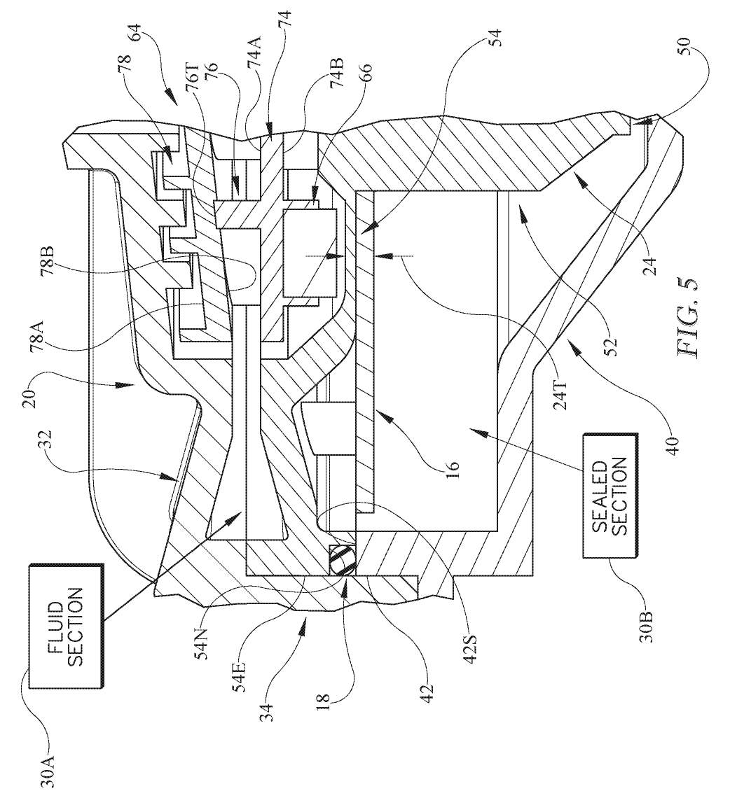

The fluid pump 10 includes a pump housing 12, an impeller assembly 14, and a printed circuit board (PCB) stator 16 as shown in FIGS. 1-5. The pump housing 12 defines a cavity 30 that is partitioned into a fluid section 30A and a sealed section 30B that is sealed off from the fluid section 30A as shown in FIGS. 4 and 5. The impeller assembly 14 is arranged in the fluid section 30A of the pump housing 12 and configured to rotate about an axis 11 to generate a flow of the fluid through the pump housing 12. The PCB stator 16 is arranged in the sealed section 30B of the pump housing 12 adjacent to a plurality of magnets 66 on an impeller 64 of the impeller assembly 14. The PCB stator 16 has copper traces 92 configured to generate a magnetic field when an alternating electrical current is introduced that interacts with the plurality of magnets 66 on the impeller body 64 to cause the impeller assembly 14 to rotate about the axis 11.

Conventional pumps may rely on radial flux motors and external impellers. This increases the complexity of the pump housing and exposes electrical components to harsh conditions. The present application incorporates the magnets 66 into the impeller 64 of the pump 10 and utilizes a PCB stator 16 for an axial flux motor. The PCB stator 16 is arranged in a fully sealed section 30B of the pump housing 12 so that the electronics of the PCB stator 16 are protected from being exposed to the fluid flowing through the pump housing 12. This may eliminate any additional mechanical couplings and may improve efficiency by integrating the impeller 64 with the magnets 66 while maintaining a fully sealed section 30B for the PCB stator 16.

With an initial description of the pump 10 provided above, the pump housing 12 includes a top housing body 20, a bottom housing body 22, and a partition 24 as shown in FIGS. 1-5. The top or first housing body 20 is coupled to the bottom or second housing body 22 to define a cavity 30 therebetween. The partition 24 is arranged in the cavity 30 axially between the bottom housing body 22 and the top housing body 20 relative to the axis 11 to divide the cavity 30 into the fluid section 30A and the sealed section 30B. The sealed section 30B is hermetically sealed from the fluid section 30A. In the illustrative embodiment, the pump 10 includes a seal member 18 arranged between the bottom housing body 22, the top housing body 20, and the partition 24 of the pump housing 12 to seal the sealed section 30B of the cavity 30 from the fluid section 30A.

The top housing body 20 includes a top wall 32, an annular outer wall 34, an inlet pipe 36, and an output pipe 38 as shown in FIGS. 1-5. The top wall 32 extends circumferentially about the axis 11. The annular outer wall 34 extends axially from an outer rim 32R of the top wall 32 toward the bottom housing body 22. The inlet pipe 36 extends axially from the top wall 32 at a center of the top wall 32 along the axis 11 away from the bottom housing body 22. The outlet pipe 38 extends radially or perpendicular to the axis 11 away from the outer wall 34.

The inlet pipe 36 defines an inlet port 36P and the output pipe 38 defines an outlet port 38P as shown in FIGS. 1-5. The inlet port 36P and the outlet port 38P both open to the fluid section 30A of the pump housing 12. In this way, when the pump 10 is operating the flow of fluid flows through the inlet pipe 36, through the fluid section 30A, and out through the outlet pipe 38.

The bottom housing body 22 includes a bottom wall 40 and an annular lip 42 as shown in FIGS. 1-5. The bottom wall 40 extends circumferentially about the axis 11. The annular lip 42 extends axially from the bottom wall 40 toward the top housing body 20. The annular lip 42 is spaced radially inward of an outer edge 40E of the bottom wall 40. The annular outer wall 34 of the top housing body 20 extends around the annular lip 42 and engages the bottom wall 40 such that the annular outer wall 34 and the annular lip 42 overlap as shown in FIG. 4. The annular lip 42 of the bottom housing body 22 provides a shoulder surface 42S that supports the seal member 18 that is arranged thereon.

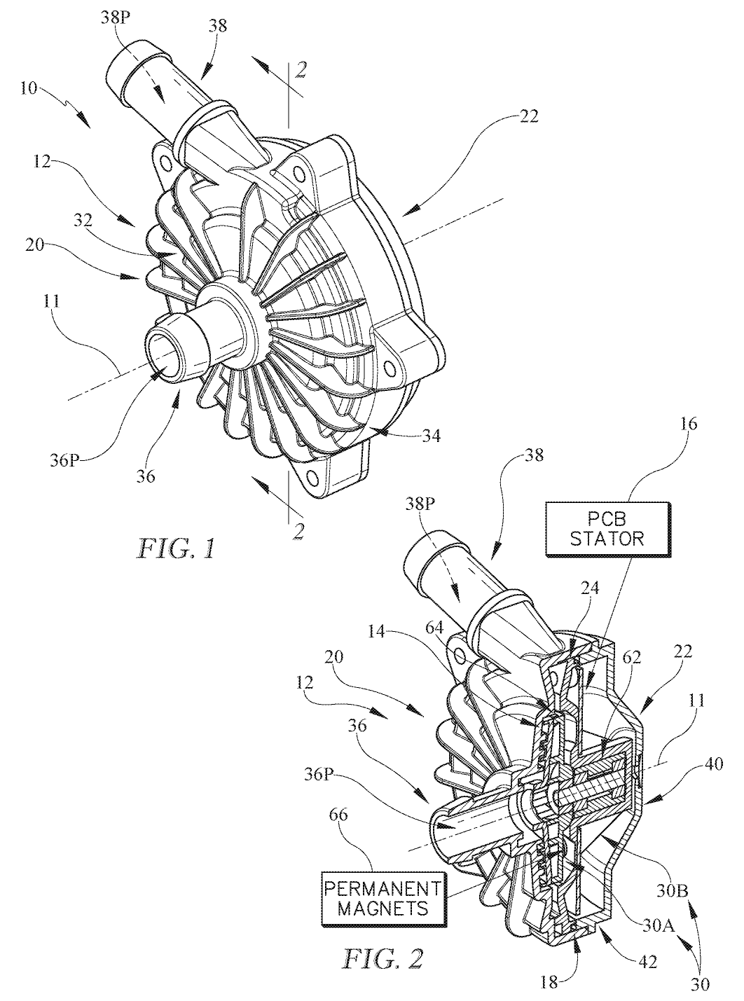

The partition 24 includes a center wall 50, a band 52, and a circumferential wall 54 as shown in FIGS. 2-5. The center wall 50 extends circumferentially about the axis 11. The band 52 extends axially away from the center wall 50 and circumferentially about the axis 11 to define an axle-receiving opening 58. A portion of an impeller axle assembly 62 is located in the axle-receiving opening 58 of the partition 24. The circumferential wall 54 extends radially outward away from the band 52 toward the annular outer wall 34 of the top housing body 20 to a terminal end 54E.

The terminal end 54E of the circumferential wall 54 defines a notch 54N that receives the seal member 18 as shown in FIGS. 4 and 5. The notch 54N receives the seal member 18 so that the seal member 18 is located between the terminal end 54E of the circumferential wall 54 of the partition 24, the annular lip 42 of the bottom housing body 22, and the annular outer wall 34 of the top housing body 20 as shown in FIGS. 4 and 5.

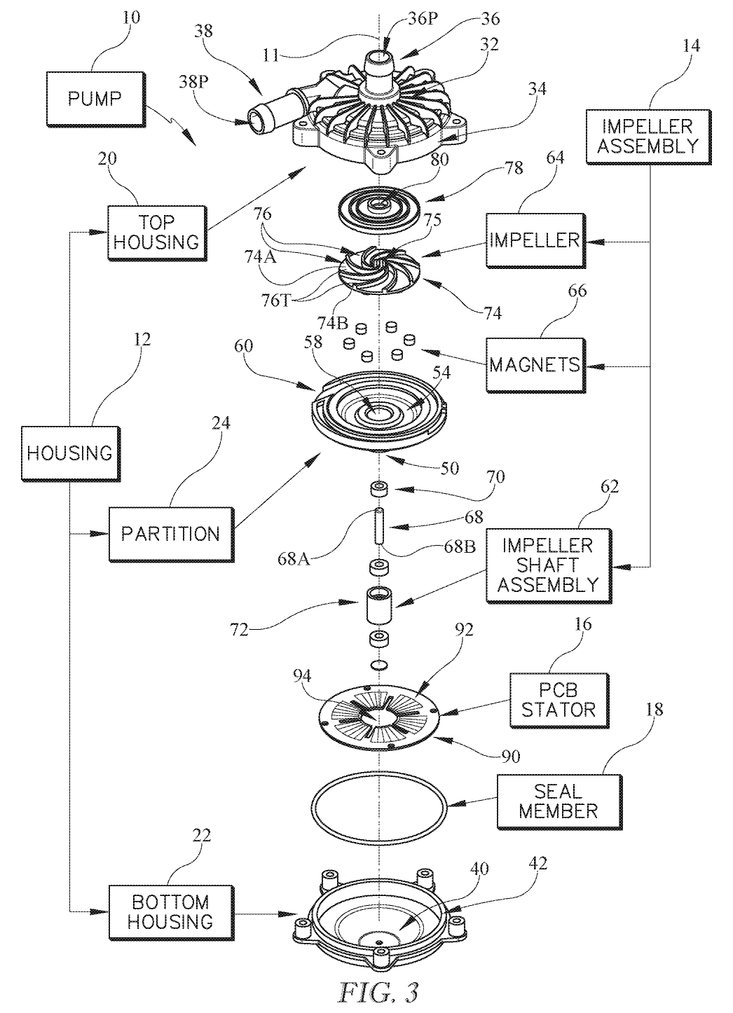

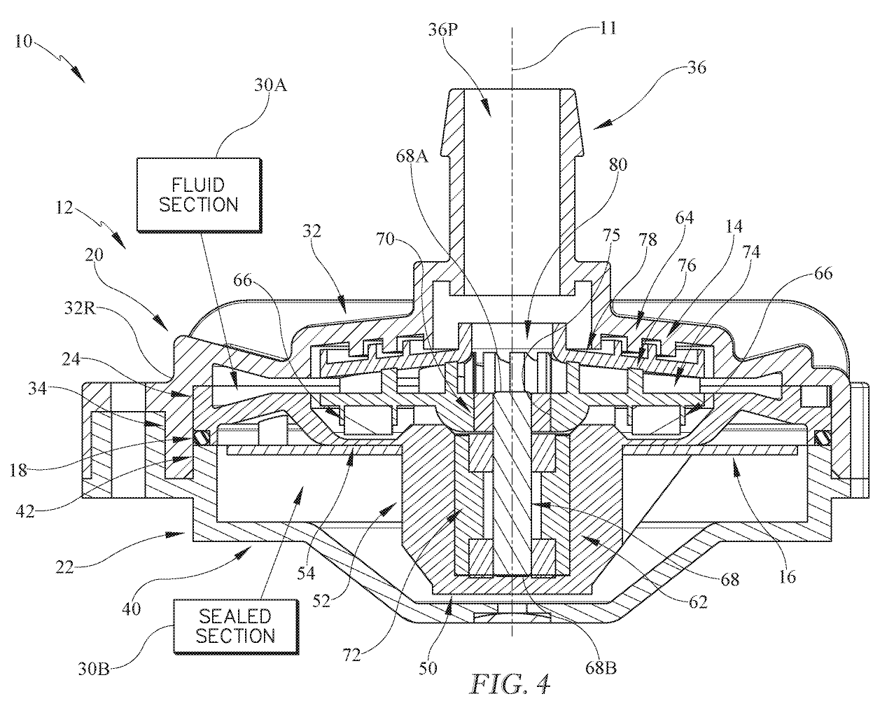

In the illustrative embodiment, the partition 24 has a channel 60 that cooperates with the top housing body 20 to form an outlet passageway as shown in FIG. 3. The outlet passageway formed between the partition 24 and the top housing body 20 is in fluid communication with the outlet port 38P. The flow of the fluid generated by the impeller assembly 14 flows through the outlet passageway and out the outlet port 38P of the outlet pipe 38.

The impeller assembly 14 includes an impeller axle assembly 62, the impeller 64, and the plurality of permanent magnets 66 as shown in FIGS. 2-5. The impeller axle assembly 62, also sometimes referred to as the impeller shaft assembly 62, extends along the axis 11 and is configured to support the impeller 64 for rotation about the axis 11. The impeller axle assembly 62 may rotate about the axis 11 in some embodiments. The impeller 64, also referred to as the impeller body 64, is configured to rotate about the axis to generate the flow of the fluid through the pump housing 12. The plurality of magnets 66 are coupled to the impeller 64 for rotation therewith about the axis 11. As shown in FIG. 3, the plurality of magnets 66 are spaced apart circumferentially about the axis 11. The plurality of magnets 66 may be arranged in different array patterns.

The impeller axle assembly 62 includes an impeller axle 68, an impeller bushing 70, and a ball bearing assembly 72 as shown in FIGS. 2-5. The impeller axle 68, also sometimes referred to as the impeller shaft 68, extends axially along the axis 11 between a first end 68A and a second end 68B spaced apart axially from the first end 68A. The impeller bushing 70 is arranged at the first end 68A of the impeller axle 68 between the impeller axle 68 and the impeller body 64. The ball bearing assembly 72 is arranged at the second end 68B of the impeller axle 68 between the impeller axle 68 and the partition 24. In the illustrative embodiment, the ball bearing assembly 72 is arranged in the axle-receiving opening 58 of the partition 24. In some embodiments, the impeller 64 may be coupled to the impeller axle assembly 62 for rotation therewith.

The impeller body 64 includes an impeller disk 74, a plurality of impeller blades 76, and an impeller shroud 78 as shown in FIGS. 2-5. The impeller disk 74 extends circumferentially about the axis 11. Each blade 76 of the plurality of impeller blades 76 extends axially away from a first side 74A of the impeller disk 74. The plurality of magnets 66 are coupled to a second side 74B of the impeller disk 74 opposite the first side 74A as shown in FIGS. 2-5. The impeller shroud 78 is arranged over the plurality of impeller blades 76 to direct the fluid through the impeller 64 in between the plurality of impeller blades 76 and impede the fluid from passing over tips 76T of the plurality of impeller blades 76.

The impeller disk 74 is formed to include an axle hole 75 as shown in FIGS. 3-5. The axle hole 75 extends axially through the impeller disk 74 along the axis 11. The axle hole 75 receives a portion of the impeller axle assembly 62. In the illustrative embodiment, the axle hole 75 receives the impeller bushing 70 and the first end 68A of the impeller axle 68.

Each blade 76 of the plurality of impeller blades 76 extends radially and circumferentially along the first side 74A of the impeller disk 74 as shown in FIG. 3. Each blade 76 extends circumferentially about the axis 11 as the blade 76 extends radially relative to the axis 11. Each blade 76 terminates before the axle hole 75 formed in the impeller disk 74. In the illustrative embodiment, the blades 76 are integrally formed with the impeller disk 74. In some embodiments, the blades 76 may be separate components that are coupled to the first side 74A of the impeller disk 74.

The impeller shroud 78 has a first side 78A that faces the top housing body 20 and a second side 78B that faces the impeller disk 74 as shown in FIGS. 4 and 5. The second side 78B is coupled to the tips 76T of the impeller blades 76 to prevent the fluid passing over the tips 76T of the impeller blades 76. The impeller shroud 78 also defines an shroud opening 80 that extends axially therethrough along the axis 11. In the illustrative embodiment, the impeller shroud 78 is a separate component from the impeller disk 74 with the integrally formed blades 76. In some embodiments, the impeller disk 74, the impeller blades 76, and the impeller shroud 78 may be a integrally formed so that the impeller disk 74, the impeller blades 76, and the impeller shroud 78 are a single piece component.

In the illustrative embodiment, the first side 78A of the impeller shroud 78 has features that cooperate with the top housing body 20 to form a tortuous flow path therebetween as shown in FIGS. 4 and 5. The tortuous flow path is configured to reduce the flow of fluid between the top housing body and the impeller body 64. In this way, the flow of fluid flowing into the pump 10 through the inlet pipe 36 flows through the shroud opening 80 into the impeller 64 and not around the impeller 64.

The PCB stator 16 is a printed circuit board (PCB) 90 that extends circumferentially about the axis 11 as shown in FIGS. 2-5. The PCB stator 16 has copper traces 92 arranged in designated areas on the PCB 90. The copper traces 92 are configured to generate the magnetic field that interacts with the plurality of magnets 66 on the impeller body 64 to cause the impeller assembly 14 to rotate about the axis 11.

As shown in FIG. 3, the copper traces 92 are arranged in a winding pattern on the PCB 90 in the designated areas. In the illustrative embodiment, the copper traces 92 have a concentrated winding pattern. In other embodiments, the copper traces 92 may have a different winding pattern.

The PCB 90 has a center aperture 94 that extends axially therethrough as shown in FIG. 3. A portion of the partition 24, i.e., the center wall 50 and the band 52, is arranged in the center aperture 94 so that the PCB stator 16 may sit flush on the circumferential wall 54 of the partition 24 as shown in FIGS. 4 and 5. The partition 24 has a relatively small or minimum axial thickness 24T at this location so that the thickness of the partition 24 is the smallest between the magnets 66 of the impeller assembly 14 and the copper traces 92 of the PCB stator 16 as shown in FIGS. 4 and 5.

Another embodiment of a fluid pump 210 in accordance with the present disclosure is shown in FIGS. 6-10. The fluid pump 210 is substantially similar to the fluid pump 10 shown in FIGS. 1-5 and described herein. Accordingly, similar reference numbers in the 200 series indicate features that are common between the fluid pump 10 and the fluid pump 210. The description of the fluid pump 10 is incorporated by reference to apply to the fluid pump 210, except in instances when it conflicts with the specific description and drawings of the fluid pump 210.

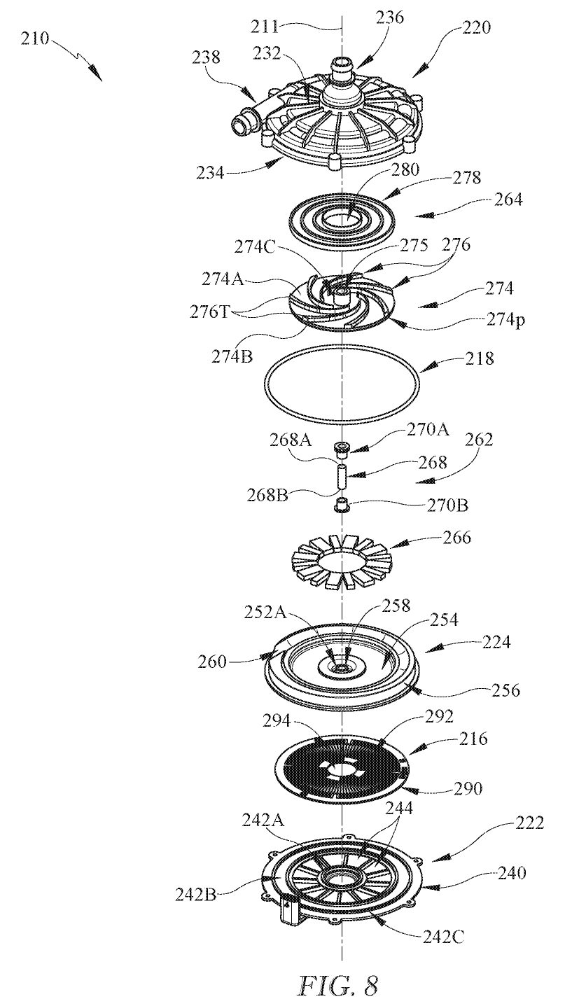

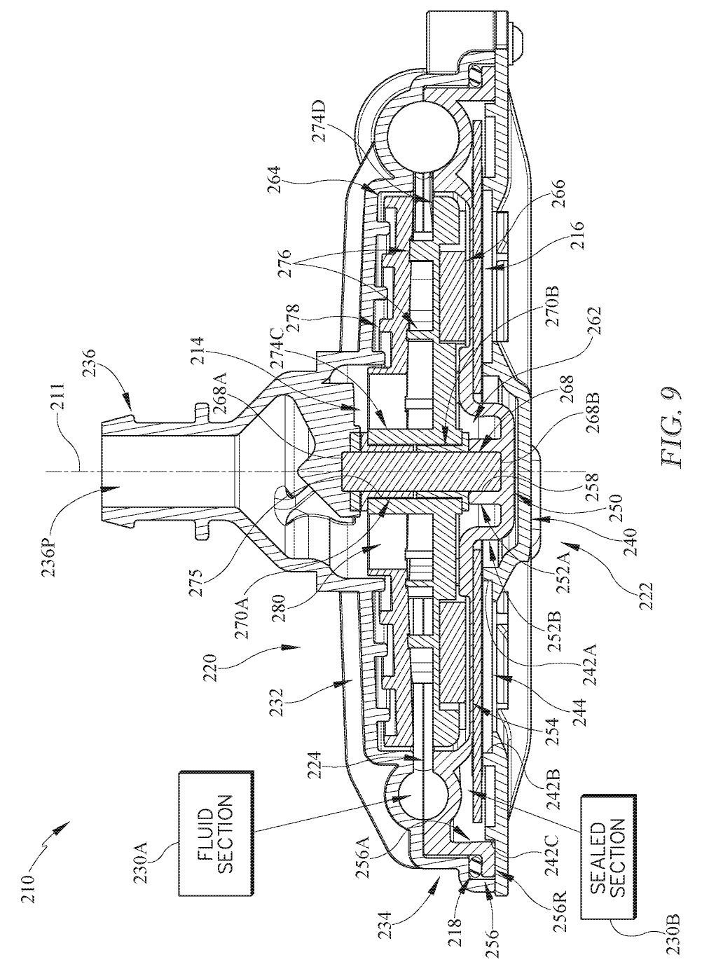

The fluid pump 210 includes a pump housing 212, an impeller assembly 214, and a printed circuit board (PCB) stator 216 as shown in FIGS. 6-10. The pump housing 212 defines a cavity 230 that is partitioned into a fluid section 230A and a sealed section 230B that is sealed off from the fluid section 230A as shown in FIGS. 7 and 9. The impeller assembly 214 is arranged in the fluid section 230A of the pump housing 212 and configured to rotate about an axis 211 to generate a flow of the fluid through the pump housing 212. The PCB stator 216 is arranged in the sealed section 230B of the pump housing 212 adjacent to a plurality of magnets 266 on an impeller 264 of the impeller assembly 214. The PCB stator 216 has copper traces configured to generate a magnetic field when an alternating electrical current is introduced that interacts with the plurality of magnets 266 on the impeller body 264 to cause the impeller assembly 214 to rotate about the axis 211.

The pump housing 212 includes a top housing body 220, a bottom housing body 222, and a partition 224 as shown in FIGS. 6-10. The top housing body 220 is coupled to the bottom housing body 222 to define a cavity 230 therebetween. The partition 224 is arranged in the cavity 230 axially between the bottom housing body 222 and the top housing body 220 relative to the axis 211 to divide the cavity 230 into the fluid section 230A and the sealed section 230B. The sealed section 230B is hermetically sealed from the fluid section 230A.

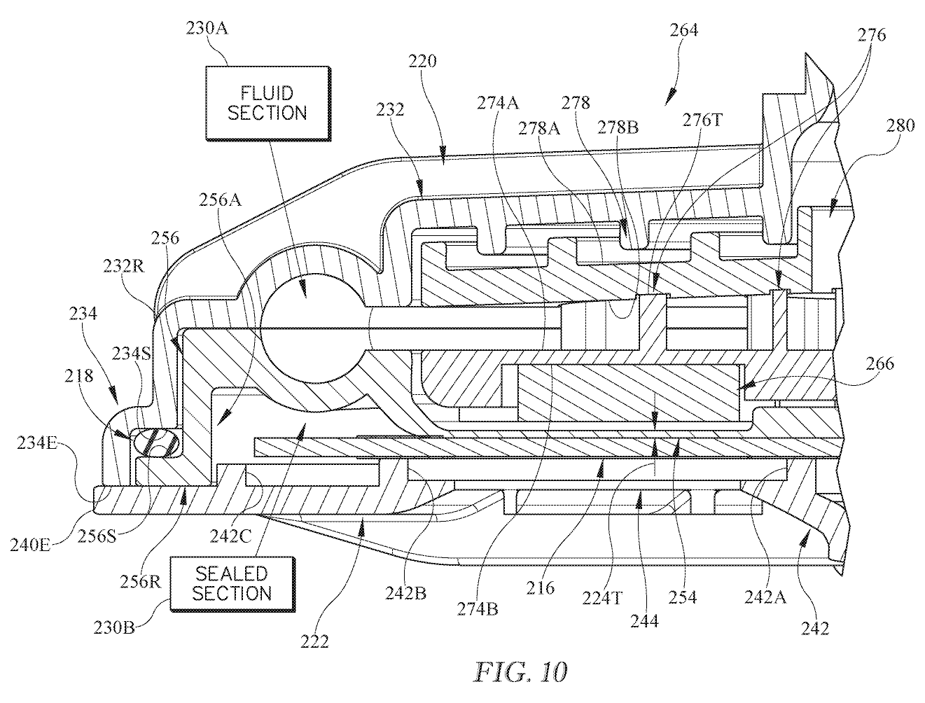

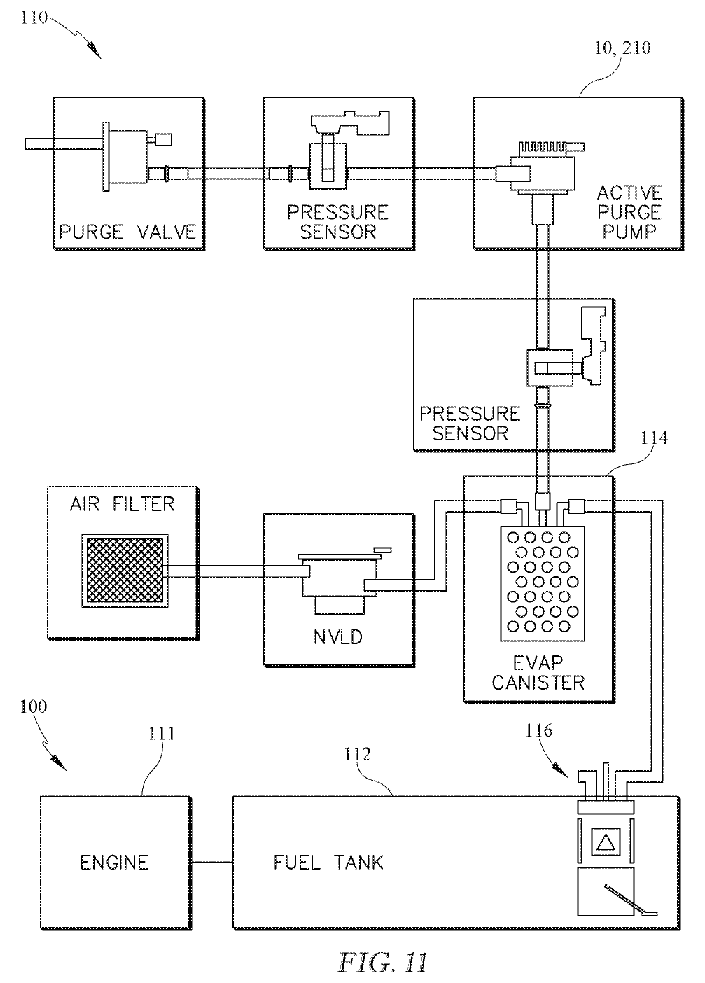

In the illustrative embodiment, the pump 210 includes a seal member 218 arranged between the top housing body 220 and the partition 224 of the pump housing 212 to seal the sealed section 230B of the cavity 230 from the fluid section 230A. As shown in FIGS. 9 and 10, the seal member 218 is arranged axially between the top housing body 220 and the partition 224. The bottom housing body 222 does not directly contact the seal member 218.

The top housing body 220 includes a top wall 232, an annular outer wall 234, an inlet pipe 236, and an output pipe 238 as shown in FIGS. 6-10. The top wall 232 extends circumferentially about the axis 211. The annular outer wall 234 extends axially from an outer rim 232R of the top wall 232 toward the bottom housing body 222. The inlet pipe 236 extends axially from the top wall 32 at a center of the top wall 232 along the axis 211 away from the bottom housing body 222. The outlet pipe 238 extends radially or perpendicular to the axis 211 away from the outer wall 234.

The annular outer wall 234 of the top housing body 220 is formed to define a shoulder surface 234S that supports the seal member 218. The annular outer wall 234 of the top housing body 220 provides the shoulder surface 234S for the seal member 218 instead of the bottom housing body 222 like in FIGS. 1-5. The seal member 218 is arranged axially between the shoulder surface 234S and the partition 224 and the annular outer wall 234 extends axially along the seal member 218 radially outward thereof.

The inlet pipe 236 defines an inlet port 236P and the output pipe 238 defines an outlet port 238P as shown in FIGS. 6-10. The inlet port 236P and the outlet port 238P both open to the fluid section 230A of the pump housing 212. In this way, when the pump 210 is operating the flow of fluid flows through the inlet pipe 236, through the fluid section 230A, and out through the outlet pipe 238.

The bottom housing body 222 includes a bottom wall 240 and a plurality of annular lips 242A-C as shown in FIGS. 1-5. The bottom wall 240 extends circumferentially about the axis 211. Each annular lip 242A-C extends axially from the bottom wall 240 toward the top housing body 220. The first annular lip 242A extends axially from the bottom wall 240 closer to or towards the axis 211. The second annular lip 242B extends axially from the bottom wall 240 at a location spaced radially outward from the first annular lip 242A. The first and second annular lips 242A, 242B engage and support the PCB stator 216 as shown in FIGS. 9 and 10. The third annular lip 242C extends axially from the bottom wall 240 at a location spaced radially outward from the second annular lip 242B closer to or towards an outer edge 240E of the bottom wall 240.

The third annular lip 242C is spaced radially inward of the outer edge 240E as shown in FIGS. 9 and 10. The annular outer wall 234 of the top housing body 220 extends around the annular lip 242 and engages the bottom wall 240 as shown in FIGS. 9 and 10. A terminal end 234E of the annular outer wall 234 engages the bottom wall 240 of the bottom housing body 222.

As shown in FIGS. 8-10, the bottom wall 240 of the bottom housing body 222 is formed to include openings 244. The openings 244 are spaced apart around the axis 11 radially between the first annular lip 242A and the second annular lip 242B. The openings 244 allow air to flow over the PCB stator 216 to help cool the pump 210. Because the sealed section 230B is sealed off from the fluid section 230A, the bottom wall 240 may be formed with the openings 244.

The partition 224 includes a center wall 250, an inner band 252A, an outer band 252B, and a circumferential wall 254, and an annular outer wall 256 as shown in FIGS. 7-9. The center wall 250 extends circumferentially about the axis 211. The inner band 252A extends axially away from the center wall 50 and circumferentially about the axis 211 to define an axle-receiving opening 258. The outer band 252B extends axially away from the center wall 50 at a location spaced radially outward from the inner band 252A and circumferentially about the axis 211. A portion of an impeller axle assembly 214 is located in the axle-receiving opening 258 of the partition 224. The circumferential wall 254 extends radially outward away from the band 252 toward the annular outer wall 34 of the top housing body 220. The annular outer wall 256 extends axially from an outer edge 254E of the circumferential wall 254 toward the bottom wall 240 of the bottom housing body 222.

The annular outer wall 256 has an axial portion 256A and a radial portion 256R as shown in FIGS. 9 and 10. The axial portion 256A extends axially from the outer edge 254E of the circumferential wall 254. The radial portion 256R extends radially outward and away from the axial portion 256A. The radial portion 256R engages the bottom wall 240 of the bottom housing body 222 at a location between the third annular lip 242C and the annular outer wall 234 of the top housing body 220.

In the illustrative embodiment, the radial portion 256R provides a shoulder surface 256S that supports the seal member 218 that is arranged thereon as shown in FIGS. 9 and 10. The seal member 218 is arranged axially between the shoulder surface 234S and the partition 224 and the shoulder surface 256S of the annular outer wall 256.

In the illustrative embodiment, the partition 224 has a channel 260 that cooperates with the top housing body 220 to form an outlet passageway as shown in FIG. 8. The outlet passageway formed between the partition 224 and the top housing body 220 is in fluid communication with the outlet port 238P. The flow of the fluid generated by the impeller assembly 214 flows through the outlet passageway and out the outlet port 238P of the outlet pipe 238.

The impeller assembly 214 includes the impeller axle assembly 262, the impeller 264, and the plurality of magnets 266 as shown in FIGS. 2-5. The impeller axle assembly 262 extends along the axis 211 and is configured to support the impeller 264 for rotation about the axis 211. The impeller 264 is configured to rotate about the axis to generate the flow of the fluid through the pump housing 212. The plurality of magnets 266 are coupled to the impeller 264 for rotation therewith.

As shown in FIG. 8, the plurality of magnets 266 are spaced apart circumferentially about the axis 11. In the illustrative embodiment, the plurality of magnets 266 are arranged in a Halbach array pattern. The pattern concentrates magnetic field on one side of the rotor or impeller 264 for improved single stator performance.

The impeller axle assembly 262 includes an impeller axle 268 and an impeller bushings 270A, 270B as shown in FIGS. 7-10. The impeller axle 268 extends axially along the axis 211 between a first end 268A and a second end 268B spaced apart axially from the first end 268A. The first end 268A of the impeller axle 268 is arranged in the axle-receiving opening 258 of the partition 224. In the illustrative embodiment the impeller axle 268 supports the impeller 264 but does not rotate. In some embodiments, the impeller axle assembly 262 may be able to rotate about the axis 211. The second end 268B of the impeller axle 268 is arranged in the top housing body 220. The impeller bushings 270A, 270B are arranged between the impeller axle 268 and the impeller body 264 to reduce friction and wear therebetween.

As shown in FIGS. 6-10, the impeller axle assembly 262 includes two impeller bushings 270A, 270B. The first impeller bushings 270A is arranged towards the first end 268A of the impeller axle 268. Instead of a ball bearing assembly like in FIGS. 1-5, the impeller axle assembly 262 includes a second impeller bushing 270B is arranged towards the second end 268B of the impeller axle 268.

The impeller body 264 includes an impeller disk 274, a plurality of impeller blades 276, and an impeller shroud 278 as shown in FIGS. 6-10. The impeller disk 274 extends circumferentially about the axis 211. Each blade 276 of the plurality of impeller blades 276 extends axially away from a first side 274A of the impeller disk 274. The plurality of magnets 266 are coupled to a second side 274B of the impeller disk 274 opposite the first side 274A as shown in FIGS. 6-10. The impeller shroud 278 is arranged over the plurality of impeller blades 276 to direct the fluid through the impeller 264 in between the plurality of impeller blades 276 and impede the fluid from passing over tips of the plurality of impeller blades 276.

The impeller disk 274 is formed to include a plate 274P and a center boss 274C as shown in FIGS. 8-10. The plate 274P extends circumferentially about the axis 211 and defines the first side 274A and the second side 274B of the impeller disk 274. The center boss 274C extends axially from the plate 274P toward the top housing body 220. The center boss 274C is formed to include an axle hole 275 that extends axially through the impeller disk 274 along the axis 211. The axle hole 275 receives a portion of the impeller axle assembly 262. In the illustrative embodiment, the axle hole 275 receives the impeller bushings 270A, 270B and the impeller axle 268.

Each blade 276 of the plurality of impeller blades 276 extends radially and circumferentially along the first side 274A of the impeller disk 274 as shown in FIG. 8. Each blade 276 extends circumferentially about the axis 211 as the blade 276 extends radially relative to the axis 211. Each blade 276 terminates before the center boss 274C of the impeller disk 274 such that the blades 276 are spaced radially outward from the center boss 274C. In the illustrative embodiment, the blades 276 are integrally formed with the impeller disk 274. In some embodiments, the blades 276 may be separate components that are coupled to the first side 274A of the impeller disk 274.

The impeller shroud 278 has a first side 278A that faces the top housing body 220 and a second side 278B that faces the impeller disk 274 as shown in FIGS. 9 and 10. The second side 278B is coupled to the tips 276T of the impeller blades 276 to prevent the fluid passing over the tips 276T of the impeller blades 276. The impeller shroud 278 also defines an shroud opening 280 that extends axially therethrough along the axis 211. In the illustrative embodiment, the impeller shroud 278 is a separate component from the impeller disk 274 with the integrally formed blades 276. In some embodiments, the impeller disk 274, the impeller blades 276, and the impeller shroud 278 may be a integrally formed so that the impeller disk 274, the impeller blades 276, and the impeller shroud 278 are a single piece component.

In the illustrative embodiment, the first side 278A of the impeller shroud 278 has features that cooperate with the top housing body 220 to form a tortuous flow path therebetween as shown in FIGS. 9 and 10. The tortuous flow path is configured to reduce the flow of fluid between the top housing body and the impeller body 264. In this way, the flow of fluid flowing into the pump 210 through the inlet pipe 236 flows through the shroud opening 280 into the impeller 264 and not around the impeller 264.

The PCB stator 216 is a printed circuit board (PCB) 290 that extends circumferentially about the axis 211 as shown in FIGS. 7-10. The PCB 290 has copper traces 292 arranged in designated areas. The copper traces 292 are configured to generate the magnetic field that interacts with the plurality of magnets 266 on the impeller body 264 to cause the impeller assembly 214 to rotate about the axis 211.

As shown in FIG. 8, the copper traces 292 are arranged in a winding pattern on the PCB 290 in the designated areas. In the illustrative embodiment, the copper traces 292 have a distributed winding pattern. The distributed winding pattern may provide better utilization of the active conductor area under the magnets 266 resulting in higher motor efficiency, less cogging, and better controllability. The PCB 290 also have an increased number of layers compared to the PCB 90 in FIGS. 1-5 due to the distributed winding pattern.

The PCB 290 has a center aperture 294 that extends axially therethrough as shown in FIG. 8. A portion of the partition 24, i.e., the center wall 50 and the band 52, is arranged in the center aperture 294 so that the PCB stator 16 may sit flush on the circumferential wall 254 of the partition 224 as shown in FIGS. 9 and 10. The partition 224 has a relatively small or minimum axial thickness 224T at this location so that the thickness of the partition 224 is the smallest between the magnets 266 of the impeller assembly 214 and the copper traces 292 of the PCB stator 216 as shown in FIGS. 9 and 10.

The fluid pumps 10, 210 may be adapted for use in various different systems 110, 120, 130 for a vehicle 100 as suggested in FIGS. 11-13. For example, the fluid pump 10, 210 may be included in a vapor recovery or fuel system 110 like as shown in FIG. 11. The fuel system 110 further includes a fuel tank 112, a canister housing 114, a fuel tank isolation valve 116 coupled between the fuel tank 112 and the canister housing 114 as shown in FIG. 11. The fuel tank 112 is in fluid communication with an engine 111 of the vehicle 100. The canister housing 114 is formed to define a storage cavity 118 containing a carbon bed configured to absorb hydrocarbons in the fuel vapor from the fuel tank 112 that flows into and out of the storage cavity 118. The fuel tank isolation valve 116 is configured to regulate the flow of fuel vapor between the fuel tank 112 and the storage cavity 118 of the canister housing 114.

The fluid pump 10, 210 may be the purge pump 10, 210 for the system 110 as shown in FIG. 11. The purge pump 10, 210 is in fluid communication with the storage cavity 118 of the canister housing 114 and is configured to draw fuel vapor from the storage cavity 118 to the fuel tank 112 during unwanted vacuum conditions in the fuel tank 112. In the illustrative embodiment, the fluid pumped by the purge pump 10, 210 is fuel vapor.

The fluid pump 10, 210 may also be included in a thermal management system 120 like as shown in FIG. 12. The thermal management system 120 furthers include a plurality of fluid circuits 122 each including a conduit configured to conduct coolant fluid therethrough and a coolant tank 124 formed to define a coolant reservoir configured to store the coolant fluid as shown in FIG. 12. Each fluid circuit is adapted to be in thermal communication with a electronic components 101A, 101B, front and rear drives 102A, 102B, a radiator 104, batteries 106, and/or a heat exchanger 108 of the vehicle 100 to transfer heat between each of the components and the coolant fluid.

The fluid pump 10, 210 may be the pump 10, 210 for the system 120 as shown in FIG. 12. The pump 10, 210 is configured to pump a flow of the coolant fluid from the coolant tank 124 through the plurality of fluid circuits 122. In the illustrative embodiment, the fluid pumped by the pump 10, 210 is coolant fluid or a refrigerant. In some embodiments, the thermal management system 120 may include more than one fluid pump 10, 210 for the different circuits. For example, the system 120 includes an electric drive pump 10, 210 and a battery pump 10, 210 as shown in FIG. 12.

The thermal management system 120 further includes valves 126A-C that control the flow of the coolant fluid between the different fluid circuits as shown in FIG. 12. The thermal management system 120 includes a first valve 126A, a second valve 126B, and a third valve 126C as shown in FIG. 12. The first valve 126A is a 3-way proportional valve to vary the flow from each of the conduit from the front and rear drives 102A, 102B. The second valve 126B is a 3-way switch valve configured to control the flow of coolant fluid in the conduit to the radiator 104. The third valve 126C is a 4-way switch valve that controls the flow of coolant fluid in the conduit to the batteries 106.

The fluid pump 10, 210 may also be included in a high-pressure washing system 130 like as shown in FIG. 13. The high-pressure washing system 130 further includes a washer fluid tank 132 and at least one washer fluid nozzle 134A-C. The washer fluid tank 132 is configured to store a washer fluid. The washer fluid nozzle 134A-C is in fluid communication with the washer fluid tank 132 and is configured to spray washer fluid on different areas of the vehicle 100, such as the front and rear windshields 103A, 103B, sensors 105, and/or cameras 107 on the vehicle 100. In the illustrative embodiment, the washing system 130 includes multiple washer fluid nozzles 134A-C for each of the different areas. As shown in FIG. 13, system 130 includes front windshield washer nozzle(s) 134A, a rear windshield nozzle 134B, and a rear sensor nozzle 134C.

The fluid pump 10, 210 is coupled in fluid communication with the washer fluid tank 132 and the washer fluid nozzle(s) 134 as shown in FIG. 13. The fluid pump provides a flow of washer fluid from the washer fluid tank 132 to the washer fluid nozzles 134A-C to clean front and rear windshields 103A, 103B, sensors 105, and/or cameras 107 on the vehicle 100. In the illustrative embodiment, the fluid pumped by the pump 10, 210 is a washer fluid.

The washing system 130 may further include at least one valve 136 that controls the flow of washer fluid as shown in FIG. 13. The valve 136 is coupled in fluid communication with the fluid pump 10, 210 to control the flow of washer fluid to the different nozzles 134A-C, i.e. the front windshield nozzles 134A, the rear windshield nozzle 134B, and the rear sensor nozzle 134C.

A method of assembling and using the fluid pumps 10, 210 may include several steps. The method may include arranging the impeller assembly 14, 214 of the pump 10, 210 in the working section 30A, 230A of the pump housing 12, 212 and arranging the PCB stator 16, 216 in the sealed section 30B, 230B of the pump housing 12, 212. To arrange the impeller assembly 14, 214 in the different sections 30A, 30B, 230A, 230B, the method may include arranging or positioning the impeller assembly 14, 214 on a first side of the partition 24, 224 and arranging or position the PCB stator 16, 216 on a second side of the partition 24, 224 opposite the first side.

To arrange or position the impeller assembly 14, 214 on the first side of the partition 24, 224, the method may include assembling the impeller axle assembly 62, 262 and inserting the impeller axle assembly 62, 262 into the axle hole 75, 275 of the impeller disk 74, 274 before arranging the impeller axial assembly 62, 262 in the axle-receiving opening 58, 258 of the partition 24, 224. The impeller assembly 14, 214 should be arrange on the first side of the partition 24, 224 so that the magnets 66, 266 face the partition 24, 224.

To arrange or position the PCB stator 16, 216 on the second side of the partition 24, 224, the method may include arranging a portion of the partition 24, 224 in the center aperture 94, 294 of the PCB stator 16, 216. The portion of the partition 24, 224 may be arranged in the center aperture 94, 294 of the PCB stator 16, 216 so that the PCB stator 16, 216 is flush with the second side of the partition 24, 224. The first and second housing bodies 20, 22, 220, 222 may then be assembled or clamped around the impeller 64, 264 and the PCB stator 16, 216 arranged on the partition 24, 224 with the seal 18, 218 therebetween.

With the pump 10, 210 assembled, the method includes generating a magnetic field or axial flux to magnetically drive the high-speed impeller assembly 14, 214. The magnetic field is generated by introducing an electrical current to the copper traces 92, 292 on the PCB stator 16, 216. The magnetic field then interacts with the plurality of magnets 66, 266 on the impeller assembly 14, 214 to cause the impeller assembly 14, 214 to rotate about the axis 11, 211.

1. A fluid pump comprising:
a pump housing including a bottom housing body, a top housing body coupled to the bottom housing body to define a cavity therebetween, and a partition arranged in the cavity axially between the bottom housing body and the top housing body relative to an axis to divide the cavity into a fluid section and a sealed section,
an impeller assembly arranged in the fluid section of the pump housing, the impeller assembly including an impeller configured to rotate about the axis to generate a flow of the fluid through the pump housing and a plurality of magnets coupled to the impeller for rotation therewith and spaced apart circumferentially about the axis, and
a printed circuit board stator arranged in the sealed section of the pump housing adjacent to the plurality of magnets of the impeller assembly, the printed circuit board stator having copper traces configured to generate a magnetic field that interacts with the plurality of magnets on the impeller to cause the impeller assembly to rotate about the axis, the printed circuit board stator arranged in the sealed section of the pump housing so that electronics of the printed circuit board stator are sealed off from the fluid to protect the electronics of the printed circuit board stator from being exposed to the fluid flowing through the pump housing.

2. The fluid pump of claim 1, further comprising a seal member arranged between the partition and at least one of the bottom housing body and the top housing body of the pump housing to seal the sealed section of the cavity from the fluid section.

3. The fluid pump of claim 1, wherein the impeller includes an impeller disk that extends circumferentially about the axis, a plurality of impeller blades that extend axially away from a first side of the impeller disk, and an impeller shroud arranged over the plurality of impeller blades to direct the fluid through the impeller in between the plurality of impeller blades and impede the fluid from passing over tips of the plurality of impeller blades.

4. The fluid pump of claim 3, wherein the plurality of magnets are coupled to a second side of the impeller disk opposite the first side.

5. The fluid pump of claim 1, wherein the printed circuit board stator has a center aperture that extends axially therethrough and a portion of the partition is arranged in the center aperture so that the printed circuit board stator sits flush on a circumferential wall of the partition.

6. The fluid pump of claim 5, wherein the circumferential wall has a minimum axial thickness at a location arranged between the plurality of magnets of the impeller assembly and the copper traces of the printed circuit board stator.

7. The fluid pump of claim 1, wherein the top housing body includes a top wall that extends circumferentially about the axis, an annular outer wall that extends axially from an outer rim of the top wall toward the bottom housing body, an inlet pipe that extends axially from the top wall at a center of the top wall away from the bottom housing body, and an outlet pipe that extends radially away from the annular outer wall.

8. The fluid pump of claim 1, wherein the bottom housing body includes a bottom wall that extends circumferentially about the axis and at least one annular lip that extends axially from the bottom wall toward the top housing body radially inward of an outer edge of the bottom wall.

9. The fluid pump of claim 8, wherein the bottom wall of the bottom housing body is formed to include a plurality of openings spaced apart circumferentially about the axis that open to a portion of the printed circuit board stator.

10. The fluid pump of claim 1, wherein the impeller assembly further includes an impeller axle assembly that extends axially through the impeller, the impeller axle assembly including an impeller axle that extends axially along the axis between a first end and a second end spaced apart axially from the first end, an impeller bushing arranged at the first end of the impeller axle between the impeller axle and the impeller, and a ball bearing assembly arranged at the second end of the impeller axle between the impeller axle and the partition.

11. The fluid pump of claim 1, wherein the impeller assembly further includes an impeller axle assembly that extends axially through the impeller, the impeller axle assembly including an impeller axle that extends axially along the axis between a first end and a second end spaced apart axially from the first end and impeller bushings arranged around the impeller axle between the impeller axle and the impeller.

12. A fluid pump comprising:
a pump housing formed to define a cavity, the pump housing including a partition arranged in the cavity to divide the cavity into a fluid section and a sealed section that is separate from the fluid section,
an impeller assembly arranged in the fluid section of the pump housing, the impeller assembly including an impeller configured to rotate about an axis to generate a flow of the fluid through the pump housing and a plurality of magnets coupled to the impeller for rotation therewith and spaced apart circumferentially about the axis, and
a printed circuit board stator arranged in the sealed section of the pump housing adjacent to the plurality of magnets of the impeller assembly, the printed circuit board stator having copper traces configured to generate a magnetic field that interacts with the plurality of magnets on the impeller to cause the impeller assembly to rotate about the axis,
wherein the printed circuit board stator is arranged in the sealed section of the pump housing so that electronics of the printed circuit board stator are sealed off from the fluid in the fluid section to protect the electronics of the printed circuit board stator from being exposed to the fluid flowing through the pump housing.

13. The fluid pump of claim 12, further comprising a seal member arranged between a portion of the pump housing and the partition to seal the sealed section of the cavity from the fluid section.

14. The fluid pump of claim 12, wherein the impeller includes an impeller disk that extends circumferentially about the axis, a plurality of impeller blades that extend axially away from a first side of the impeller disk, and an impeller shroud arranged over the plurality of impeller blades to direct the fluid through the impeller in between the plurality of impeller blades and impede the fluid from passing over tips of the plurality of impeller blades.

15. The fluid pump of claim 14, wherein the plurality of magnets are coupled to a second side of the impeller disk opposite the first side.

16. The fluid pump of claim 12, wherein the printed circuit board stator has a center aperture that extends axially therethrough and a portion of the partition is arranged in the center aperture so that the printed circuit board stator sits flush on a circumferential wall of the partition.

17. The fluid pump of claim 16, wherein the circumferential wall has a minimum axial thickness at a location arranged between the plurality of magnets of the impeller assembly and the copper traces of the printed circuit board stator.

18. The fluid pump of claim 12, wherein the pump housing further includes a first housing body and a second housing body coupled to the first housing body to define the cavity therebetween, wherein the impeller assembly is arranged axially between the first housing body and the partition in the fluid section of the cavity, and wherein the printed circuit board stator is arranged axially between the partition and the second housing body in the sealed section of the cavity.

19. The fluid pump of claim 18, wherein the second housing body is formed to include a plurality of openings spaced apart circumferentially about the axis that open to a portion of the printed circuit board stator.

20. A thermal management system adapted for use on a vehicle, the thermal management system comprising:
a plurality of fluid circuits that each includes a conduit configured to conduct coolant fluid therethrough and adapted to be in thermal communication with at least one of (i) front and rear drives included in the vehicle to transfer heat between the front and rear drives and the coolant fluid, (ii) a radiator included in the vehicle to transfer heat between the radiator and the coolant fluid, (iii) batteries included in the vehicle to transfer heat between the batteries and the coolant fluid, and (iv) a heat exchanger to transfer heat between the coolant fluid and a fluid in the heat exchanger,
a coolant tank formed to define a coolant reservoir configured to store the coolant fluid, and
at least one pump configured to pump a flow of the coolant fluid from the coolant tank through the plurality of fluid circuits, the at least one pump comprising:
a pump housing including a first housing body, a second housing body coupled to the first housing body to define a cavity therebetween, and a partition arranged in the cavity axially between the first housing body and the second housing body relative to an axis to divide the cavity into a coolant fluid section and a sealed section,
an impeller assembly arranged in the coolant fluid section of the pump housing, the impeller assembly including an impeller configured to rotate about the axis to generate a flow of the coolant fluid through the pump housing, and a plurality of magnets coupled to the impeller for rotation therewith and spaced apart circumferentially about the axis, and
a printed circuit board stator arranged in the sealed section of the pump housing adjacent to the plurality of magnets of the impeller assembly, the printed circuit board stator having copper traces configured to generate a magnetic field that interacts with the plurality of magnets on the impeller to cause the impeller assembly to rotate about the axis, the printed circuit board stator arranged in the sealed section of the pump housing so that electronics of the printed circuit board stator are sealed off from the coolant fluid to protect the electronics of the printed circuit board stator from being exposed to the coolant fluid flowing through the pump housing.
